(19) United States
(12) Patent Application Publication
(10) Pub. No.: US 2023/0281439 A1
(43) Pub. Date: Sep. 7, 2023

(54) SYNTHETIC TIME SERIES DATA ASSOCIATED WITH PROCESSING EQUIPMENT

(71) Applicant: Applied Materials, Inc., Santa Clara, CA (US)

(72) Inventor: Joshua Thomas Maher, Sunnyvale, CA (US)

(21) Appl. No.: 17/688,650

(22) Filed: Mar. 7, 2022

(51) Int. Cl. G06N 3/08; G06N 3/04

(52) U.S. Cl. CPC G06N 3/08; G06N 3/0445; G06N 3/0454; G06Q 50/04

(57) ABSTRACT

A method includes providing a random or pseudo-random input to a first trained machine learning model trained to generate synthetic sensor time series data for a processing chamber. The method further includes providing first data indicative of one or more attributes of target synthetic sensor time series data to the first trained machine learning model. The method further includes receiving an output from the first trained machine learning model. The output includes synthetic sensor time series data associated with the processing chamber. The output is generated in view of the first data indicative of the one or more attributes.

### TECHNICAL FIELD

The present disclosure relates to methods associated with machine learning models. More particularly, the present disclosure relates to methods for generating and utilizing synthetic data with machine learning models associated with processing equipment.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application. Machine learning models are used in various process control and predictive functions associated with manufacturing equipment. Machine learning models are trained using data associated with the manufacturing equipment.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

A method includes providing a random or pseudo-random input to a first trained machine learning model trained to generate synthetic sensor time series data for a processing chamber. The method further includes providing first data indicative of one or more attributes of target synthetic sensor time series data to the first trained machine learning model. The method further includes receiving an output from the first trained machine learning model. The output includes synthetic sensor time series data associated with the processing chamber. The output is generated in view of the first data indicative of the one or more attributes.

In another aspect of the disclosure, a system including memory and a processing device coupled to the memory is disclosed. The processing device is configured to perform operations. The operations include providing a random or pseudo-random input to a first trained machine learning model. The first trained machine learning model is trained to generate synthetic sensor time series data for a processing chamber. The operations further include providing first data indicative of one or more attributes of target synthetic sensor time series data to the first trained machine learning model. The operations further include receiving an output from the first trained machine learning model. The output includes synthetic sensor time series data associated with the processing chamber. The output is generated in view of the first data indicative of one or more attributes.

In another aspect, a non-transitory machine-readable storage medium is disclosed. The non-transitory machine-readable storage medium stores instructions which, when executed, cause a processing device to perform operations. The operations include providing a random or pseudo-random input to a first trained machine learning model trained to generate synthetic sensor time series data for a processing chamber. The operations further include providing first data indicative of one or more attributes of target synthetic sensor time series data to the first trained machine learning model. The operations further include receiving an output from the first trained machine learning model. The output includes synthetic sensor time series data associated with the processing chamber. The output is generated in view of the first data indicative of one or more attributes.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to some embodiments.

FIGS. 2A-B depict block diagrams of example data set generators to create data sets for models, according to some embodiments.

FIG. 3 is a block diagram illustrating a system for generating output data, according to some embodiments.

FIGS. 4A-C are flow diagrams of methods associated with generating one or more machine learning models for generating predictive data, according to some embodiments.

FIGS. 5A-B are block diagrams of example machine learning architecture for generating synthetic data, according to some embodiments.

FIG. 6 is a block diagram illustrating a computer system, according to some embodiments.

### DETAILED DESCRIPTION

Described herein are technologies related to generating synthetic time trace data, such as may be used to train a machine learning model. Manufacturing equipment is used to produce products, such as substrates (e.g., wafers, semiconductors). Manufacturing equipment may include a manufacturing or processing chamber to separate the substrate from the environment. The properties of produced substrates are to meet target values to facilitate specific functionalities. Manufacturing parameters are selected to produce substrates that meet the target property values. Many manufacturing parameters (e.g., hardware parameters, process parameters, etc.) contribute to the properties of processed substrates. Manufacturing systems may control parameters by specifying a set point for a property value and receiving data from sensors disposed within the manufacturing chamber, making adjustments to the manufacturing equipment until the sensor readings match the set point. In some embodiments, trained machine learning models are utilized to improve performance of manufacturing equipment.

Machine learning models may be applied in several ways associated with processing chambers and/or manufacturing equipment. A machine learning model may receive as input sensor data, measuring values of properties in a processing chamber. The machine learning model may be configured to predict process results, e.g., metrology results of the finished product. A machine learning model may receive as input in-situ data associated with the work piece or substrate, e.g., reflectance spectroscopy of a semiconductor wafer during an etch process. The machine learning model may be configured to predict and control process results, e.g., may predict when an etch process is completed and sent instructions to the processing chamber to stop the etch operation. In some embodiments, a machine learning model may accept as input metrology data of a finished product. The machine learning model may be configured to produce as output a prediction of a root cause (e.g., processing fault) of an anomaly of the product. These are a few representative examples of the uses of machine learning in association with manufacturing equipment, among many others.

In some embodiments, a large volume of time trace data is used to train a machine learning model, e.g., data associated with hundreds of processing runs. Data may include many time traces, e.g., time traces associated with hundreds of sensors, time traces associated with multiple processing operations of a processing run, etc.

In some embodiments, performance of manufacturing equipment changes over time. In some processes, materials may be deposited on chamber components as products are processed, e.g., substrate supports, valves and actuators, showerheads, etc., may accumulate layers of various processing materials or byproducts. In some processes, material may be removed from various chamber components, e.g., by a corrosive gas or plasma. As components of a manufacturing system gradually change, conditions experienced by the work piece (e.g., substrate, semiconductor wafer, etc.) may be affected. Properties of finished products (e.g., substrate metrology) may also shift with changing conditions.

To avoid unpredictable chamber conditions, maintenance is performed on processing equipment. In some cases, one or more components are replaced. In some cases, seasoning operations are performed. Some maintenance operations are performed as part of planned maintenance events, e.g., maintenance events performed according to a schedule to maintain acceptable performance of equipment. Some maintenance operations are performed as part of unplanned maintenance events, e.g., maintenance events initiated responsive to a system fault, unexpected system or component failure, etc.

Slow drift and sudden changes (e.g., maintenance, component replacement, etc.) may alter a relationship between set points and property values in a processing chamber. For example, as a chamber ages or if a heating element is replaced, a set point for the heater (e.g., power provided to the heater) may result in a different temperature profile at the location of a substrate. In some embodiments, the relationship between sensor data and conditions proximate to the substrate may be affected by a change in the processing chamber. Machine learning models trained to perform functions associated with processing equipment (e.g., generating predictive data) may provide less reliable functionality as chamber conditions change.

A machine learning model may be configured to recognize, categorize, or utilize a rare feature in trace data, e.g., classify a fault in manufacturing equipment based on sensor data input. In some embodiments, most processing runs do not indicate a fault in equipment - most processing runs generate normal processing conditions, utilizing normally functional components.

Training a machine learning model may be expensive. A machine learning model is generally trained with a large number of data samples in order for the machine learning model to be accurate. For example, a machine learning model may be configured to receive, as input, sensor data and produce, as output, a prediction of metrology of a finished product. In training the machine learning model, metrology data and associated sensor data of many (e.g., hundreds) of products (e.g., substrates) may be provided to the machine learning model. A trained machine learning model may only provide useful (e.g., accurate) data for a narrow range of situations. For example, a trained machine learning model may only be applicable to one processing chamber, one substrate design, one process recipe, etc. Producing enough data to train a machine learning model may involve significant expenditure, e.g., in raw materials, processing time, energy, reagents, equipment wear and tear, expenditure to generate metrology data, etc. While generating training data, processing equipment may be operated without the protection of predictive data from one or more machine learning models. Processing equipment may be operated at conditions which increase wear on components without predictive machine learning data. The lifetime of components may be decreased by being operated in sub-optimal conditions.

The expense of generating sufficient training data to produce a trained machine learning model with appreciable predictive power is compounded by changing chamber quality, e.g., due to drift, maintenance, etc. As chamber quality changes (e.g., as components experience drift, are replaced, etc.), predictive power of machine learning models associated with the processing chamber may deteriorate. To maintain adequate predictive power, the machine learning models may be retrained. Data from further product processing, metrology, etc., may be utilized for training the machine learning models. Such a strategy involves generating a large amount of training data for the altered processing chamber. The chamber may be offline (e.g., may not be producing products for use, for sale, etc.) while generating the new training data. A processing system may undergo changes regularly. The offline time (e.g., downtime to generate training data) may become inconvenient or expensive.

Expense of generating sufficient training data may also be compounded by the intended function of the machine learning model, e.g., anomaly detection, fault root cause classification, etc. Faults in operable manufacturing systems are often rare. Many processing runs may be performed before a fault occurs. In some embodiments, a small number of processing runs may be performed before a fault is corrected. Collecting sufficient fault-indicative data may take an unreasonable amount of time under normal operations. In some cases, manufacturing equipment may intentionally be operated with a fault (e.g., a failing or aging component) to collect training data. In some cases, operating manufacturing equipment with a fault may increase stress on the manufacturing system. Increased stress may decrease the lifetime of the manufacturing system, increasing expense of components, maintenance, downtime, express shipping of parts, etc.

The methods and devices of the present disclosure may address one or more of these deficiencies of conventional solutions. In some embodiments, one or more machine learning models associated with a processing chamber are to be trained. In some embodiments, the training data includes time trace data, e.g., sensor data. In some embodiments, a limited amount of training data is available. In some embodiments, a limited amount of one or more types of training data is available, e.g., data indicative of an impending fault in various subsystems, etc. In some embodiments, one or more machine learning models (e.g., an ensemble model including several models in parallel) may be used to generate synthetic time trace training data.

Synthetic time trace data may be generated using a machine learning model. In some embodiments, a relatively small volume of true data (e.g., data collected by sensors during a processing run, measured sensor time series data) may be used to train a model to generate synthetic time trace data. The generator model may be configured to generate synthetic data that matches distribution of the true data, e.g., that is statistically similar to the true data.

In some embodiments, data used to train the generator model may be labeled with one or more attributes. Attributes may include labels identifying the source of the data, e.g., sensor type, sensor location, information about the processing recipe or operation, etc. Attributes may include labels identifying a state of the manufacturing system, for example, a label of a fault present in the processing equipment, an indication of time since installation or maintenance of the manufacturing equipment, etc.

In some embodiments, generation of synthetic data may include the use of a generative adversarial network (GAN). A GAN is a type of unsupervised (e.g., training input is provided to the model without providing a target output during training operations) machine learning model. A basic GAN includes two parts: a generator and a discriminator. The generator produces synthetic data, e.g., time trace sensor data. The discriminator is then provided with synthetic data and true data, e.g., data collected by a sensor during a processing run. The discriminator attempts to label data as true or synthetic (e.g., distinguish synthetic from true data), and the generator attempts to generate synthetic data that cannot be distinguished as synthetic by the discriminator. Once the generator achieves a target efficiency (e.g., reaches a threshold portion of output that the discriminator does not classify as synthetic), the generator may be used to produce synthetic data for use in other applications.

In some embodiments, the generator may be configured to produce output in accordance with certain attributes, e.g., may be configured to produce output related to training data taken while a fault was present in manufacturing equipment. In this way, a relatively small amount of training data may be used to train the GAN, and the generator may produce a large amount of data with features indicative of a fault in the manufacturing equipment (e.g., for use in training a machine learning model configured to predict faults). In some embodiments, a sufficient volume of training data is available to train a machine learning model, and the data was collected under well-controlled processing conditions. In some embodiments, well-controlled processing conditions may generate data sets over many processing runs that capture little variation in conditions. In some embodiments, a machine learning model trained on similar data may lack robustness, e.g., may perform poorly if even a relatively small change in conditions occurs. In some embodiments, a generator may be configured to produce noisy output. The noisy output may be utilized to train a machine learning model. The machine learning model trained using noisy synthetic data may be more robust to changing conditions of the manufacturing equipment than a machine learning model trained strictly on true data.

Aspects of the present disclosure result in technological advantages compared to conventional solutions. Aspects of the present disclosure result in more efficient machine learning model training and data generation/collection. Training of a machine learning model may be performed with a large amount of data. In embodiments, a portion (e.g., optionally a large portion) of the data used to train the machine learning model is synthetic data generated according to embodiments described herein. The large volume of data used to train a chamber may be further exacerbated by changing chamber conditions (e.g., aging and drift, component replacement, maintenance, etc.), target rare events (e.g., fault or anomaly detection), etc. In conventional systems, a large number of processing runs may be performed to generate the training data. This may result in a large amount of wasted material, a large amount of chamber downtime, expended energy, etc. In some embodiments, a processing chamber control system may be performed or partially performed by a machine learning model. These processing chambers may be operated outside ideal conditions in generating training data (e.g., operated without the assistance of the associated controlling model). Utilizing the methods of generating training data presented in this disclosure may reduce material expenditure, time expenditure, energy expenditure, uncontrolled chamber usage, etc., in generating data for training (or retraining) a machine learning model. In some embodiments, a chamber may be intentionally operated with a fault to generated training data indicative of the fault. This practice may place additional stress on components of the manufacturing system, decreasing component lifetime, increasing maintenance frequency, etc. By utilizing a machine learning model to generate synthetic data, such expenditures may be reduced. Training data may be generated that provides additional robustness, protects against overfitting, and may be targeted to specific applications (e.g., data with a specific set of attributes).

Aspects of the present disclosure describe a method, including providing a random or pseudo-random input to a first trained machine learning model trained to generate synthetic sensor time series data for a processing chamber. The method further includes providing first data indicative of one or more attributes of target synthetic sensor time series data to the first trained machine learning model. The method further includes receiving an output from the first trained machine learning model. The output includes synthetic sensor time series data associated with the processing chamber. The output is generated in view of the first data indicative of the one or more attributes.

In another aspect of the disclosure, a system including memory and a processing device coupled to the memory is disclosed. The processing device is configured to perform operations. The operations include providing a random or pseudo-random input to a first trained machine learning model. The first trained machine learning model is trained to generate synthetic sensor time series data for a processing chamber. The operations further include providing first data indicative of one or more attributes of target synthetic sensor time series data to the first trained machine learning model. The operations further include receiving an output from the first trained machine learning model. The output includes synthetic sensor time series data associated with the processing chamber. The output is generated in view of the first data indicative of one or more attributes.

In another aspect, a non-transitory machine-readable storage medium is disclosed. The non-transitory machine-readable storage medium stores instructions which, when executed, cause a processing device to perform operations. The operations include providing a random or pseudo-random input to a first trained machine learning model trained to generate synthetic sensor time series data for a processing chamber. The operations further include providing first data indicative of one or more attributes of target synthetic sensor time series data to the first trained machine learning model. The operations further include receiving an output from the first trained machine learning model. The output includes synthetic sensor time series data associated with the processing chamber. The output is generated in view of the first data indicative of one or more attributes.

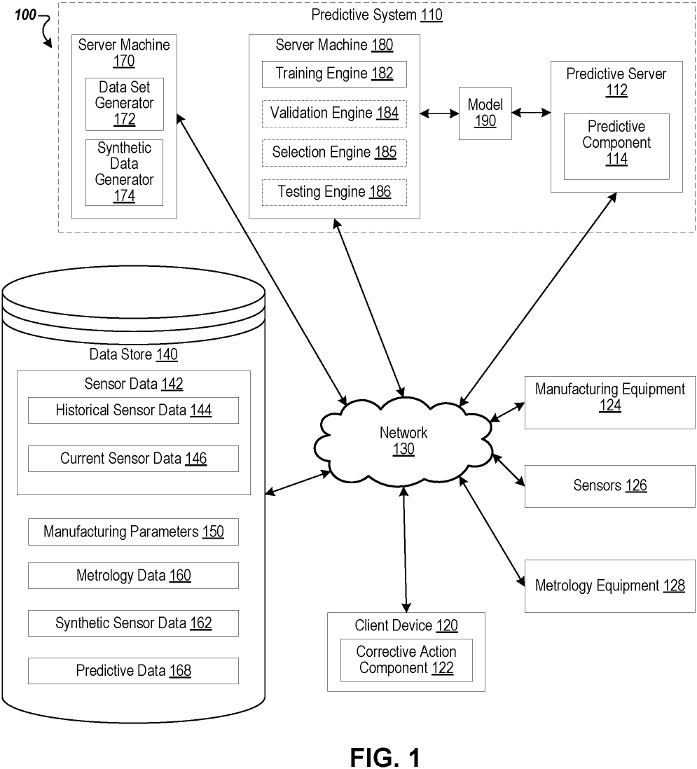

FIG. 1 is a block diagram illustrating an exemplary system 100 (exemplary system architecture), according to some embodiments. The system 100 includes a client device 120, manufacturing equipment 124, sensors 126, metrology equipment 128, predictive server 112, and data store 140. The predictive server 112 may be part of predictive system 110. Predictive system 110 may further include server machines 170 and 180.

Sensors 126 may provide sensor data 142 associated with manufacturing equipment 124 (e.g., associated with producing, by manufacturing equipment 124, corresponding products, such as substrates). Sensor data 142 may be used to ascertain equipment health and/or product health (e.g., product quality). Manufacturing equipment 124 may produce products following a recipe or performing runs over a period of time. In some embodiments, sensor data 142 may include values of one or more of optical sensor data, spectral data, temperature (e.g., heater temperature), spacing (SP), pressure, High Frequency Radio Frequency (HFRF), radio frequency (RF) match voltage, RF match current, RF match capacitor position, voltage of Electrostatic Chuck (ESC), actuator position, electrical current, flow, power, voltage, etc. Sensor data 142 may include historical sensor data 144 and current sensor data 146. Current sensor data 146 may be associated with a product currently being processed, a product recently processed, a number of recently processed products, etc. Current sensor data 146 may be used as input to a trained machine learning model, e.g., to generate predictive data 168. Historical sensor data 144 may include data stored associated with previously produced products. Historical sensor data 144 may be used to train a machine learning model, e.g., model 190. Historical sensor data 144 and/or current sensor data 146 may include attribute data, e.g., labels of manufacturing equipment ID or design, sensor ID, type, and/or location, label of a state of manufacturing equipment, such as a present fault, service lifetime, etc.

Sensor data 142 may be associated with or indicative of manufacturing parameters such as hardware parameters (e.g., hardware settings or installed components, e.g., size, type, etc.) of manufacturing equipment 124 or process parameters (e.g., heater settings, gas flow, etc.) of manufacturing equipment 124. Data associated with some hardware parameters and/or process parameters may, instead or additionally, be stored as manufacturing parameters 150, which may include historical manufacturing parameters (e.g., associated with historical processing runs) and current manufacturing parameters. Manufacturing parameters 150 may be indicative of input settings to the manufacturing device (e.g., heater power, gas flow, etc.). Sensor data 142 and/or manufacturing parameters 150 may be provided while the manufacturing equipment 124 is performing manufacturing processes (e.g., equipment readings while processing products). Sensor data 142 may be different for each product (e.g., each substrate). Substrates may have property values (film thickness, film strain, etc.) measured by metrology equipment 128. Metrology data 160 may be a component of data store 140.

In some embodiments, sensor data 142, metrology data 160, or manufacturing parameters 150 may be processed (e.g., by the client device 120 and/or by the predictive server 112). Processing of the sensor data 142 may include generating features. In some embodiments, the features are a pattern in the sensor data 142, metrology data 160, and/or manufacturing parameters 150 (e.g., slope, width, height, peak, etc.) or a combination of values from the sensor data 142, metrology data, and/or manufacturing parameters (e.g., power derived from voltage and current, etc.). Sensor data 142 may include features and the features may be used by predictive component 114 for performing signal processing and/or for obtaining predictive data 168 for performance of a corrective action.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, a processing device (e.g., via a machine learning model) may be used to generate synthetic sensor data 162. Synthetic sensor data may be processed in any of the ways described above in connection with sensor data 142, e.g., generating features, combining values, linking data from a particular recipe, chamber, or substrate, etc. Synthetic sensor data 162 may share features with sensor data 142, e.g., may have features in common with current sensor data 146, historical sensor data 144, etc.

In some embodiments, predictive system 110 may generate predictive data 168 using supervised machine learning (e.g., predictive data 168 includes output from a machine learning model that was trained using labeled data, such as sensor data labeled with metrology data, etc.). In some embodiments, predictive system 110 may generate predictive data 168 using unsupervised machine learning (e.g., predictive data 168 includes output from a machine learning model that was trained using unlabeled data, output may include clustering results, principle component analysis, anomaly detection, etc.). In some embodiments, predictive system 110 may generate predictive data 168 using semi-supervised learning (e.g., training data may include a mix of labeled and unlabeled data, etc.).

Client device 120, manufacturing equipment 124, sensors 126, metrology equipment 128, predictive server 112, data store 140, server machine 170, and server machine 180 may be coupled to each other via network 130 for generating predictive data 168 to perform corrective actions. In some embodiments, network 130 may provide access to cloud-based services. Operations performed by client device 120, predictive system 110, data store 140, etc., may be performed by virtual cloud-based devices.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Client device 120 may include computing devices such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. Client device 120 may include a corrective action component 122. Corrective action component 122 may receive user input (e.g., via a Graphical User Interface (GUI) displayed via the client device 120) of an indication associated with manufacturing equipment 124. In some embodiments, corrective action component 122 transmits the indication to the predictive system 110, receives output (e.g., predictive data 168) from the predictive system 110, determines a corrective action based on the output, and causes the corrective action to be implemented. In some embodiments, corrective action component 122 obtains sensor data 142 (e.g., current sensor data 146) associated with manufacturing equipment 124 (e.g., from data store 140, etc.) and provides sensor data 142 (e.g., current sensor data 146) associated with the manufacturing equipment 124 to predictive system 110. In some embodiments, corrective action component 122 stores sensor data 142 in data store 140 and predictive server 112 retrieves sensor data 142 from data store 140. In some embodiments, predictive server 112 may store output (e.g., predictive data 168) of the trained model(s) 190 in data store 140 and client device 120 may retrieve the output from data store 140. In some embodiments, corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

In some embodiments, metrology data 160 corresponds to historical property data of products (e.g., produced using manufacturing parameters associated with historical sensor data 144 and historical manufacturing parameters of manufacturing parameters 150) and predictive data 168 is associated with predicted property data (e.g., of products to be produced or that have been produced in conditions recorded by current sensor data 146 and/or current manufacturing parameters). In some embodiments, predictive data 168 is predicted metrology data (e.g., virtual metrology data) of the products to be produced or that have been produced according to conditions recorded as current sensor data 146 and/or current manufacturing parameters. In some embodiments, the predictive data 168 is an indication of abnormalities (e.g., abnormal products, abnormal components, abnormal manufacturing equipment 124, abnormal energy usage, etc.) and one or more causes of the abnormalities. In some embodiments, predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like. In some embodiments, predictive data 168 is an indication of progress of a processing operation being performed, e.g., to be used for process control.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product) into predictive system 110, receiving output of predictive data 168, and performing a corrective action based on the predictive data 168, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting sensor data 142 (e.g., manufacturing parameters that are being used or are to be used to manufacture a product), receiving output of predictive data 168, and performing corrective action (e.g., predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting the sensor data 142 into the trained model 190, receiving an output of predictive data 168, and performing (e.g., based on the predictive data 168) a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters.

Corrective actions may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process if the predictive data 168 indicates a predicted abnormality, such as an abnormality of the product, a component, or manufacturing equipment 124). In some embodiments, a machine learning model is trained to monitor the progress of a processing run (e.g., monitor in-situ sensor data to predict if a manufacturing process has reached completion). In some embodiments, the machine learning model may send instructions to end a processing run when the model determines that the process is complete. In some embodiments, the corrective action includes providing feedback control (e.g., modifying a manufacturing parameter responsive to the predictive data 168 indicating a predicted abnormality). In some embodiments, performance of the corrective action includes causing updates to one or more manufacturing parameters. In some embodiments performance of a corrective action may include retraining a machine learning model associated with manufacturing equipment 124. In some embodiments, performance of a corrective action may include training a new machine learning model associated with manufacturing equipment 124.

Manufacturing parameters 150 may include hardware parameters (e.g., information indicative of which components are installed in manufacturing equipment 124, indicative of component replacements, indicative of component age, indicative of software version or updates, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., altering the timing of manufacturing subsystems entering an idle or active mode, altering set points of various property values, etc.).

Predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc. Operations of predictive server 112, server machine 170, server machine 180, data store 140, etc., may be performed by a cloud computing service, cloud data storage service, etc.

Predictive server 112 may include a predictive component 114. In some embodiments, the predictive component 114 may receive current sensor data 146, and/or current manufacturing parameters (e.g., receive from the client device 120, retrieve from the data store 140) and generate output (e.g., predictive data 168) for performing corrective action associated with the manufacturing equipment 124 based on the current data. In some embodiments, predictive component 114 may use one or more trained machine learning models 190 to determine the output for performing the corrective action based on current data.

In some embodiments, manufacturing equipment 124 may have one or more machine learning models associated with it. Machine learning models associated with manufacturing equipment 124 may perform a variety of functions. Machine learning models may be configured to accept as input time trace sensor data and produce as output predicted metrology data. Time trace sensor data may include values measured by sensors associated with a manufacturing process as a processing operation occurs, e.g., data taken at sequential time points. In some embodiments, time trace data may include a value measured every second, ten times a second, one hundred times a second, or another interval. In some embodiments, time trace sensor data may not be collected at even (e.g., equal) intervals. Time trace sensor data may further be referred to as time series data, sensor time series data, etc. Time trace sensor data may include ordered measurements (e.g., sequential in time) of temperature proximate to a sensor, pressure in a processing chamber, spectral data such as reflectance measurements, transmission measurements, etc., electrical properties such as voltage or current, radio frequency wavelength or amplitude, etc. Machine learning models may be configured to accept as input time trace sensor data (e.g., spectral data of a wafer) and produce as output an estimate of process progress. Other machine learning models accepting as input time trace data associated with manufacturing equipment 124 are possible and within the scope of this disclosure. The output of a machine learning model (e.g., machine learning model 190) may be stored as predictive data 168 in data store 140.

Manufacturing equipment 124 may be associated with one or more machine leaning models, e.g., model 190. Machine learning models associated with manufacturing equipment 124 may perform many tasks, including process control, classification, performance predictions, etc. Model 190 may be trained using data associated with manufacturing equipment 124 or products processed by manufacturing equipment 124, e.g., sensor data 142 (e.g., collected by sensors 126), manufacturing parameters 150 (e.g., associated with process control of manufacturing equipment 124), metrology data 160 (e.g., generated by metrology equipment 128), etc. One type of machine learning model that may be used to perform some or all of the above tasks is an artificial neural network, such as a deep neural network. Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). A recurrent neural network (RNN) is another type of machine learning model. A recurrent neural network model is designed to interpret a series of inputs where inputs are intrinsically related to one another, e.g., time trace data, sequential data, etc. Output of a perceptron of an RNN is fed back into the perceptron as input, to generate the next output. Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In some embodiments, predictive component 114 receives current sensor data 146 and/or current manufacturing parameters 154, performs signal processing to break down the current data into sets of current data, provides the sets of current data as input to a trained model 190, and obtains outputs indicative of predictive data 168 from the trained model 190. In some embodiments, predictive data is indicative of metrology data (e.g., prediction of substrate quality). In some embodiments, predictive data is indicative of component health. In some embodiments, predictive data is indicative of processing progress (e.g., utilized to end a processing operation).

In some embodiments, the various models discussed in connection with model 190 (e.g., supervised machine learning model, unsupervised machine learning model, etc.) may be combined in one model (e.g., an ensemble model), or may be separate models. Predictive component 114 may receive current sensor data 146 and current manufacturing parameters 154, provide the data to a trained model 190, and receive information indicative of how much several components in the manufacturing chamber have drifted from their previous performance. Data may be passed back and forth between several distinct models included in model 190 and predictive component 114. In some embodiments, some or all of these operations may instead be performed by a different device, e.g., client device 120, server machine 170, server machine 180, etc. It will be understood by one of ordinary skill in the art that variations in data flow, which components perform which processes, which models are provided with which data, and the like are within the scope of this disclosure.

Data store 140 may be a memory (e.g., random access memory), a drive (e.g., a hard drive, a flash drive), a database system, a cloud-accessible memory system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, synthetic sensor data 162, and predictive data 168. Sensor data 142 may include historical sensor data 144 and current sensor data 146. Sensor data may include sensor data time traces over the duration of manufacturing processes, associations of data with physical sensors, pre-processed data, such as averages and composite data, and data indicative of sensor performance over time (i.e., many manufacturing processes). Manufacturing parameters 150 and metrology data 160 may contain similar features. Historical sensor data 144 and historical manufacturing parameters may be historical data (e.g., at least a portion of these data may be used for training model 190). Current sensor data 146 may be current data (e.g., at least a portion to be input into learning model 190, subsequent to the historical data) for which predictive data 168 is to be generated (e.g., for performing corrective actions). Synthetic sensor data 162 may include data including representative features of several different data, e.g., may include features of old sensor data 148 (e.g., sensor data generated before training model 190) and features of new sensor data 149 (e.g., sensor data generated after training model 190).

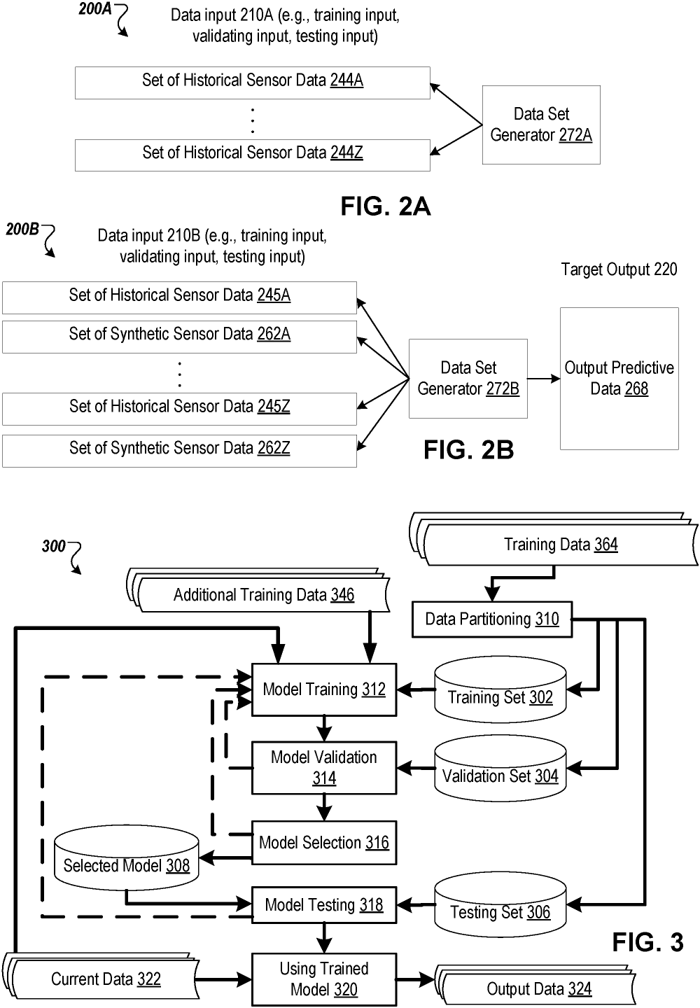

In some embodiments, predictive system 110 further includes server machine 170 and server machine 180. Server machine 170 includes a data set generator 172 that is capable of generating data sets (e.g., a set of data inputs and a set of target outputs) to train, validate, and/or test model(s) 190, including one or more machine learning models. Some operations of data set generator 172 are described in detail below with respect to FIGS. 2A-B and 4A. In some embodiments, data set generator 172 may partition the historical data (e.g., historical sensor data 144, historical manufacturing parameters, synthetic sensor data 162 stored in data store 140) into a training set (e.g., sixty percent of the historical data), a validating set (e.g., twenty percent of the historical data), and a testing set (e.g., twenty percent of the historical data). In some embodiments, predictive system 110 (e.g., via predictive component 114) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

Server machine 170 may include synthetic data generator 174. Synthetic data generator 174 may include one or more trained machine learning models. Synthetic data generator 174 may be trained using sensor data 142, e.g., collected by sensors 126. Synthetic data generator 174 may be configured to generate synthetic sensor data, e.g., synthetic time trace sensor data. Synthetic sensor data 162 may resemble historical sensor data 144. Synthetic sensor data 162 may be used to train machine learning model 190, e.g., for generation of predictive data 168 for performance of a corrective action. Data set generator 172 may combine sensor data 142 and synthetic sensor data 162 to generate training, testing, validating, etc., data sets.

In some embodiments, machine learning model 190 is provided historical data as training data. In some embodiments, machine learning model 190 is provided synthetic sensor data 168 as training data. The historical and/or synthetic sensor data may be or include time trace data in some embodiments. The type of data provided will vary depending on the intended use of the machine learning model. For example, a machine learning model may be trained by providing the model with historical sensor data 144 as training input and corresponding metrology data 160 as target output. In some embodiments, a large volume of data is used to train model 190, e.g., sensor and metrology data of hundreds of substrates may be used. In some embodiments, a fairly small volume of data is available to train model 190, e.g., model 190 is to be trained to recognize a rare event such as equipment failure, model 190 is to be trained to generate predictions of a newly seasoned or maintained chamber, etc. Synthetic data may be generated to augment available true data (e.g., data generated by sensors 126) in training model 190.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a model 190 using one or more sets of features associated with the training set from data set generator 172. The training engine 182 may generate multiple trained models 190, where each trained model 190 corresponds to a distinct set of features of the training set (e.g., sensor data from a distinct set of sensors). For example, a first trained model may have been trained using all features (e.g., X1-X5), a second trained model may have been trained using a first subset of the features (e.g., X1, X2, X4), and a third trained model may have been trained using a second subset of the features (e.g., X1, X3, X4, and X5) that may partially overlap the first subset of features. Data set generator 172 may receive the output of a trained model (e.g., synthetic sensor data 162 from synthetic data generator 174), collect that data into training, validation, and testing data sets, and use the data sets to train a second model (e.g., a machine learning model configured to output predictive data, corrective actions, etc.).

Validation engine 184 may be capable of validating a trained model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained models 190 based on the corresponding sets of features of the validation set. Validation engine 184 may discard trained models 190 that have an accuracy that does not meet a threshold accuracy. In some embodiments, selection engine 185 may be capable of selecting one or more trained models 190 that have an accuracy that meets a threshold accuracy. In some embodiments, selection engine 185 may be capable of selecting the trained model 190 that has the highest accuracy of the trained models 190.

Testing engine 186 may be capable of testing a trained model 190 using a corresponding set of features of a testing set from data set generator 172. For example, a first trained machine learning model 190 that was trained using a first set of features of the training set may be tested using the first set of features of the testing set. Testing engine 186 may determine a trained model 190 that has the highest accuracy of all of the trained models based on the testing sets.

In the case of a machine learning model, model 190 may refer to the model artifact that is created by training engine 182 using a training set that includes data inputs and corresponding target outputs (correct answers for respective training inputs). Patterns in the data sets can be found that map the data input to the target output (the correct answer), and machine learning model 190 is provided mappings that capture these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network, recurrent neural network), etc. Synthetic data generator 174 may include one or more machine learning models, which may include one or more of the same types of models (e.g., artificial neural network).

In some embodiments, one or more machine learning models 190 may be trained using historical data (e.g., historical sensor data 144). In some embodiments, models 190 may have been trained using synthetic sensor data 162, or a combination of historical data and synthetic data. In some embodiments, synthetic data generator 174 may be trained using historical data. For example, synthetic data generator 174 may be trained using historical sensor data 144 to generate synthetic sensor data 162. In some embodiments, synthetic data generator 174 may include a generative adversarial network (GAN). A GAN includes at least a generator and a discriminator. The generator attempts to generate data (e.g., time trace sensor data) similar to input data (e.g., true sensor data). The discriminator attempts to distinguish true data from synthetic data (e.g., distinguish synthetic from measured sensor time series data). Training the GAN includes the generator becoming more adept at generating data that resembles true sensor data, and the discriminator becoming more adept at distinguishing true from synthetic data. A trained GAN includes a generator that is configured to generate synthetic data that includes many features of the true data used to train it. In some embodiments, the input data may be labelled with one or more attributes, such as information about the tool, sensor or product associated with the input data. In some embodiments, the generator may be configured to produce synthetic data with a certain set of attributes, e.g., synthetic data associated with a target sensor, target processing operation, and target processing equipment fault.

Utilizing synthetic sensor data 162 in training machine learning model 190 has significant technical advantages over other methods.

In some embodiments, a large amount of data (e.g., hundreds of substrates) may be used to train a machine learning model. It may be expensive to generate such a volume of data, e.g., in raw materials expended, process gasses, energy, time, equipment wear, etc. A relatively small volume of data (e.g., less data than is to be used to train model 190) may be readily available for training. By supplying the smaller amount of true data to synthetic data generator 174, and using synthetic sensor data 162 to train machine learning model 190, expense related to performing additional processing runs may be avoided. A large volume of data associated with a set of attributes may be generated and supplied to train a machine learning model 190. In some embodiments, synthetic sensor data 162 with more variance than true sensor data may be generated. In some embodiments, the conditions in a processing chamber may be reproduced so consistently that using only true senor data to train a machine learning model may negatively impact the ability of the machine learning model to account for variations in input data. Supplying relatively more noisy data, e.g., synthetic sensor data 162, to train machine learning model 190 may allow the machine learning model to be more robust to natural variations in processing operations of the manufacturing equipment.

Predictive component 114 may provide current data to model 190 and may run model 190 on the input to obtain one or more outputs. For example, predictive component 114 may provide current sensor data 146 to model 190 and may run model 190 on the input to obtain one or more outputs. Predictive component 114 may be capable of determining (e.g., extracting) predictive data 168 from the output of model 190. Predictive component 114 may determine (e.g., extract) confidence data from the output that indicates a level of confidence that predictive data 168 is an accurate predictor of a process associated with the input data for products produced or to be produced using the manufacturing equipment 124 at the current sensor data 146 and/or current manufacturing parameters. Predictive component 114 or corrective action component 122 may use the confidence data to decide whether to cause a corrective action associated with the manufacturing equipment 124 based on predictive data 168.

The confidence data may include or indicate a level of confidence that the predictive data 168 is an accurate prediction for products or components associated with at least a portion of the input data. In one example, the level of confidence is a real number between 0 and 1 inclusive, where 0 indicates no confidence that the predictive data 168 is an accurate prediction for products processed according to input data or component health of components of manufacturing equipment 124 and 1 indicates absolute confidence that the predictive data 168 accurately predicts properties of products processed according to input data or component health of components of manufacturing equipment 124. Responsive to the confidence data indicating a level of confidence below a threshold level for a predetermined number of instances (e.g., percentage of instances, frequency of instances, total number of instances, etc.) predictive component 114 may cause trained model 190 to be re-trained (e.g., based on current sensor data 146, current manufacturing parameters, etc.). In some embodiments, retraining may include generating one or more data sets (e.g., via data set generator 172) utilizing historical data and/or synthetic data.

For purpose of illustration, rather than limitation, aspects of the disclosure describe the training of one or more machine learning models 190 using historical data (e.g., historical sensor data 144, historical manufacturing parameters) and inputting current data (e.g., current sensor data 146, current manufacturing parameters, and current metrology data) into the one or more trained machine learning models to determine predictive data 168. In other embodiments, a heuristic model, physics-based model, or rule-based model is used to determine predictive data 168 (e.g., without using a trained machine learning model). In some embodiments, such models may be trained using historical and/or synthetic data. In some embodiments, these models may be retrained utilizing a combination of true historical data and synthetic data. Predictive component 114 may monitor historical sensor data 144, historical manufacturing parameters, and metrology data 160. Any of the information described with respect to data inputs 210 of FIGS. 2 may be monitored or otherwise used in the heuristic, physics-based, or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine. In some embodiments, functions of client device 120, predictive server 112, server machine 170, server machine 180, and data store 140 may be performed by a cloud-based service.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, process control, or the like.

FIGS. 2A-B depict block diagrams of example data set generators 272A-B (e.g., data set generator 172 of FIG. 1) to create data sets for training, testing, validating, etc. a model (e.g., model 190 of FIG. 1), according to some embodiments. Each data set generator 272 may be part of server machine 170 of FIG. 1. In some embodiments, several machine learning models associated with manufacturing equipment 124 may be trained, used, and maintained (e.g., within a manufacturing facility). Each machine learning model may be associated with one data set generators 272, multiple machine learning models may share a data set generator 272, etc.

System 200A containing data set generator 272A (e.g., data set generator 172 of FIG. 1) creates data sets for one or more unsupervised machine learning models (e.g., synthetic data generator 174 of FIG. 1). Data set generator 272A may create data sets (e.g., data input 210A) using historical data. Example data set generator 272A is configured to generate data sets for a machine learning model configured to take as input sensor data and produce as output synthetic sensor data (e.g., for use in training another machine learning model). Analogous data set generators (or analogous operations of data set generator 272A) may be utilized for machine learning models configured to perform different functions, e.g., a machine learning model configured to receive as input sensor data and produce as output clustering operations, predictions of an anomaly, etc.

Data set generator 272A may generate data sets to train, test, and validate a machine learning model. The machine learning model is provided with set of historical sensor data 244A (e.g., historical sensor data of a substrate processing run) as data input 210A. The machine learning model may include two or more separate models (e.g., the machine learning model may be an ensemble model). The machine learning model may be configured to generate synthetic data that resembles the training input. In some embodiments, training may not include providing target output to the machine learning model. The machine learning model may include one or more data generators and one or more discriminators. During training operations, a generator may produce data resembling the input sensor data. The discriminator may be provided with input data and synthetic data, and attempt to distinguish between them. As training proceeds, the discriminator becomes more adept at identifying synthetic data, and the generator becomes more adept at producing data similar to the input sensor data (e.g., becomes more adept at “fooling” the discriminator).

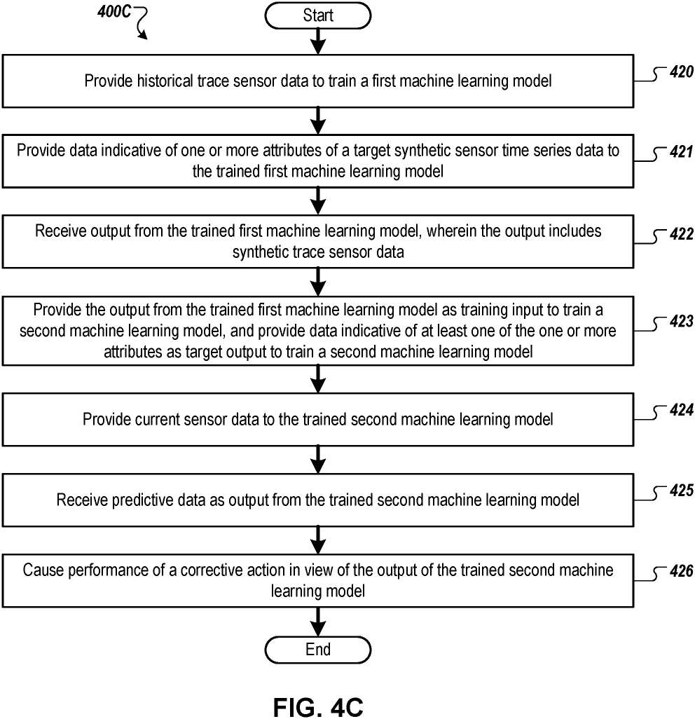

In some embodiments, data set generator 272A generates a data set (e.g., training set, validating set, testing set) that includes one or more data inputs 210A (e.g., training input, validating input, testing input). Data inputs 210A may also be referred to as “features,” “attributes,” or “information.” In some embodiments, data set generator 272A may provide the data set to the training engine 182, validating engine 184, or testing engine 186, where the data set is used to train, validate, or test the machine learning model (e.g., synthetic data generator 174 of FIG. 1). Some embodiments of generating a training set are further described with respect to FIG. 4A.

In some embodiments, data input 210A may include one or more sets of data. As an example, system 200A may produce sets of sensor data that may include one or more of sensor data from one or more types of sensors, combination of sensor data from one or more types of sensors, patterns from sensor data from one or more types of sensors, manufacturing parameters combinations from one or more manufacturing parameters, combinations of some manufacturing parameter data and some sensor data, etc. patterns from sensor data from one or more types of sensors, manufacturing parameters combinations from one or more manufacturing parameters, combinations of some manufacturing parameter data and some sensor data, etc.

In some embodiments, data set generator 272A may generate a first data input corresponding to a first set of historical sensor data 244A to train, validate, or test a first machine learning model and the data set generator 272A may generate a second data input corresponding to a second set of historical sensor data 244B to train, validate, or test a second machine learning model.

Data inputs 210A to train, validate, or test a machine learning model may include information for a particular manufacturing chamber (e.g., for particular substrate manufacturing equipment). In some embodiments, data inputs 210A may include information for a specific type of manufacturing equipment, e.g., manufacturing equipment sharing specific characteristics. Training a machine learning model based on a type of equipment may allow the trained model to generate plausible synthetic sensor data for a group of manufacturing equipment.

In some embodiments, subsequent to generating a data set and training, validating, or testing a machine learning model using the data set, the model may be further trained, validated, or tested, or adjusted (e.g., adjusting weights or parameters associated with input data of the model, such as connection weights in a neural network).

FIG. 2B depicts a system 200B including data set generator 272B for creating data sets for one or more supervised machine learning models (e.g., model 190 of FIG. 1). Data set generator 272B may create data sets (e.g., data input 210B, target output 220) using historical data and/or synthetic sensor data (e.g., output from synthetic data generator 174 of FIG. 1). In some embodiments, synthetic sensor data may be utilized to train an unsupervised machine learning model, e.g., target output 220 may not be generated by data set generator 272B. Data set generator 272B may share many features and functions with data set generator 272A.

Data set generator 272B may generate data sets to train, test, and validate a machine learning model. The machine learning model is provided with set of historical sensor data 245A and/or set of synthetic sensor data 262A as data input 210B. The machine learning model may be configured to accept current sensor data as input data and generate predictive data, clustering data, anomaly detection data, etc. as output. In some embodiments, generation of historical sensor data may be expensive. Data sets may be generated including synthetic sensor data which may reduce the cost of generating training data.

Data set generator 272B may be used to generate data for any type of machine learning model that takes as input sensor trace data. Data set generator 272B may be used to generate data for a machine learning model that generates predicted metrology data of a substrate. Data set generator 272B may be used to generate data for a machine learning model configured to provide process control instructions. Data set generator 272B may be used to generate data for a machine learning model configured to identify a product anomaly and/or processing equipment fault.

In some embodiments, data set generator 272B generates a data set (e.g., training set, validating set, testing set) that includes one or more data inputs 210B (e.g., training input, validating input, testing input). Data inputs 210B may be provided to training engine 182, validating engine 184, or testing engine 186. The data set may be used to train, validate, or test the machine learning model (e.g., model 190 of FIG. 1).

In some embodiments, data input 210B may include one or more sets of data. As an example, system 200B may produce sets of sensor data that may include one or more of sensor data from one or more types of sensors, combinations of sensor data from one or more types of sensors, patterns from sensor data from one or more types of sensors, and/or synthetic versions thereof.

In some embodiments, data set generator 272B may generate a first data input corresponding to a first set of historical sensor data 245A and/or a first set of synthetic sensor data 262A to train, validate, or test a first machine learning model. Data set generator 272B may generate a second data input corresponding to a second set of historical sensor data 245B and/or a second set of synthetic sensor data 262B to train, validate, or test a second machine learning model.

In some embodiments, data set generator 272B generates a data set (e.g., training set, validating set, testing set) that includes one or more data inputs 210B (e.g., training input, validating input, testing input) and may include one or more target outputs 220 that correspond to the data inputs 210B. The data set may also include mapping data that maps the data inputs 210B to the target outputs 220. In some embodiments, data set generator 272B may generate data for training a machine learning model configured to make predictions, by generating data sets including output predictive data 268. Data inputs 210B may also be referred to as “features,” “attributes,” or “information.” In some embodiments, data set generator 272B may provide the data set to the training engine 182, validating engine 184, or testing engine 186, where the data set is used to train, validate, or test the model 190 (e.g., one of the machine learning models that are included in model 190, ensemble model 190, etc.).

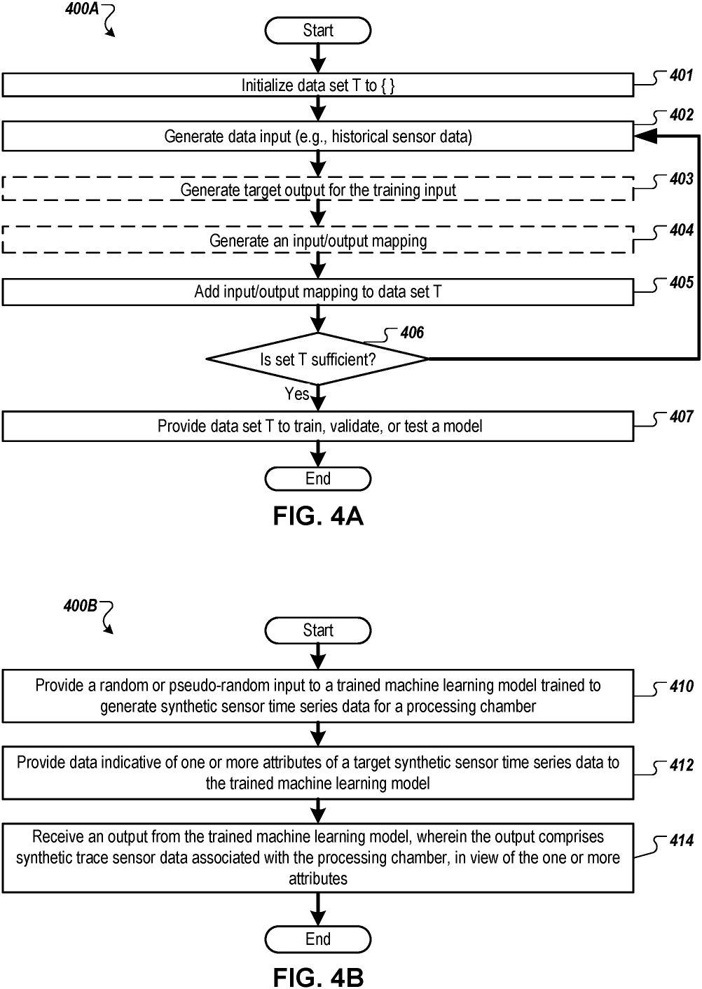

FIG. 3 is a block diagram illustrating system 300 for generating output data (e.g., synthetic sensor data 162 of FIG. 1), according to some embodiments. In some embodiments, system 300 may be used in conjunction with a machine learning model configured to generate synthetic trace sensor data (e.g., synthetic data generator 174 of FIG. 1). In some embodiments, system 300 may be used in conjunction with a machine learning model to determine a corrective action associated with manufacturing equipment. In some embodiments, system 300 may be used in conjunction with a machine learning model to determine a fault of manufacturing equipment. In some embodiments, system 300 may be used in conjunction with a machine learning model to cluster or classify substrates. System 300 may be used in conjunction with a machine learning model with a different function than those listed, associated with a manufacturing system.

At block 310, system 300 (e.g., components of predictive system 110 of FIG. 1) performs data partitioning (e.g., via data set generator 172 of server machine 170 of FIG. 1) of data to be used in training, validating, and/or testing a machine learning model. In some embodiments, training data 364 includes historical data, such as historical sensor time trace data, historical metrology data, historical classification data (e.g., classification of whether a product meets performance thresholds), etc. In some embodiments, training data 364 may include synthetic sensor data, e.g., generated by synthetic data generator 174 of FIG. 1. Training data 364 may undergo data partitioning at block 310 to generate training set 302, validation set 304, and testing set 306. For example, the training set may be 60% of the training data, the validation set may be 20% of the training data, and the testing set may be 20% of the training data.

The generation of training set 302, validation set 304, and testing set 306 can be tailored for a particular application. For example, the training set may be 60% of the training data, the validation set may be 20% of the training data, and the testing set may be 20% of the training data. System 300 may generate a plurality of sets of features for each of the training set, the validation set, and the testing set. For example, if training data 364 includes sensor data, including features derived from sensor data from 20 sensors (e.g., sensors 126 of FIG. 1) and 10 manufacturing parameters (e.g., manufacturing parameters that correspond to the sensor data from the 20 sensors), the sensor data may be divided into a first set of features including sensors 1-10 and a second set of features including sensors 11-20. The manufacturing parameters may also be divided into sets, for instance a first set of manufacturing parameters including parameters 1-5, and a second set of manufacturing parameters including parameters 6-10. Either target input, target output, both, or neither may be divided into sets. Multiple models may be trained on different sets of data.

At block 312, system 300 performs model training (e.g., via training engine 182 of FIG. 1) using training set 302. Training of a machine learning model and/or of a physics-based model (e.g., a digital twin) may be achieved in a supervised learning manner, which involves providing a training dataset including labeled inputs through the model, observing its outputs, defining an error (by measuring the difference between the outputs and the label values), and using techniques such as deep gradient descent and backpropagation to tune the weights of the model such that the error is minimized. In many applications, repeating this process across the many labeled inputs in the training dataset yields a model that can produce correct output when presented with inputs that are different than the ones present in the training dataset. In some embodiments, training of a machine learning model may be achieved in an unsupervised manner, e.g., labels or classifications may not be supplied during training. An unsupervised model may be configured to anomaly detection, result clustering, etc.

For each training data item in the training dataset, the training data item may be input into the model (e.g., into the machine learning model). The model may then process the input training data item (e.g., a process recipe from a historical processing run) to generate an output. The output may include, for example, synthetic sensor readings. The output may be compared to a label of the training data item (e.g., actual sensor readings that were measured).

Processing logic may then compare the generated output (e.g., synthetic sensor readings) to the label (e.g., actual sensor readings) that was included in the training data item. Processing logic determines an error (i.e., a classification error) based on the differences between the output and the label(s). Processing logic adjusts one or more weights and/or values of the model based on the error.

In the case of training a neural network, an error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

System 300 may train multiple models using multiple sets of features of the training set 302 (e.g., a first set of features of the training set 302, a second set of features of the training set 302, etc.). For example, system 300 may train a model to generate a first trained model using the first set of features in the training set (e.g., sensor data from sensors 1-10) and to generate a second trained model using the second set of features in the training set (e.g., sensor data from sensors 11-20). In some embodiments, the first trained model and the second trained model may be combined to generate a third trained model (e.g., which may be a better predictor or synthetic data generator than the first or the second trained model on its own). In some embodiments, sets of features used in comparing models may overlap (e.g., first set of features being sensor data from sensors 1-15 and second set of features being sensors 5-20). In some embodiments, hundreds of models may be generated including models with various permutations of features and combinations of models.

At block 314, system 300 performs model validation (e.g., via validation engine 184 of FIG. 1) using the validation set 304. The system 300 may validate each of the trained models using a corresponding set of features of the validation set 304. For example, system 300 may validate the first trained model using the first set of features in the validation set (e.g., sensor data from sensors 1-10) and the second trained model using the second set of features in the validation set (e.g., sensor data from sensors 11-20). In some embodiments, system 300 may validate hundreds of models (e.g., models with various permutations of features, combinations of models, etc.) generated at block 312. At block 314, system 300 may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312 where the system 300 performs model training using different sets of features of the training set. Responsive to determining that one or more of the trained models has an accuracy that meets a threshold accuracy, flow continues to block 316. System 300 may discard the trained models that have an accuracy that is below the threshold accuracy (e.g., based on the validation set).

At block 316, system 300 performs model selection (e.g., via selection engine 185 of FIG. 1) to determine which of the one or more trained models that meet the threshold accuracy has the highest accuracy (e.g., the selected model 308, based on the validating of block 314). Responsive to determining that two or more of the trained models that meet the threshold accuracy have the same accuracy, flow may return to block 312 where the system 300 performs model training using further refined training sets corresponding to further refined sets of features for determining a trained model that has the highest accuracy.

At block 318, system 300 performs model testing (e.g., via testing engine 186 of FIG. 1) using testing set 306 to test selected model 308. System 300 may test, using the first set of features in the testing set (e.g., sensor data from sensors 1-10), the first trained model to determine the first trained model meets a threshold accuracy (e.g., based on the first set of features of the testing set 306). Responsive to accuracy of the selected model 308 not meeting the threshold accuracy (e.g., the selected model 308 is overly fit to the training set 302 and/or validation set 304 and is not applicable to other data sets such as the testing set 306), flow continues to block 312 where system 300 performs model training (e.g., retraining) using different training sets corresponding to different sets of features (e.g., sensor data from different sensors). Responsive to determining that selected model 308 has an accuracy that meets a threshold accuracy based on testing set 306, flow continues to block 320. In at least block 312, the model may learn patterns in the training data to make predictions or generate synthetic data, and in block 318, the system 300 may apply the model on the remaining data (e.g., testing set 306) to test the predictions.

At block 320, system 300 uses the trained model (e.g., selected model 308) to receive current data 322 (e.g., current sensor data 146 of FIG. 1) and determines (e.g., extracts), from the output of the trained model, output data 324 (e.g., predictive data 168 of FIG. 1). A corrective action associated with the manufacturing equipment 124 of FIG. 1 may be performed in view of output data 324. In some embodiments, current data 322 may correspond to the same types of features in the historical data used to train the machine learning model. In some embodiments, current data 322 corresponds to a same type of features as a subset of the types of features in historical data that are used to train selected model 308.

In some embodiments, operations of using the trained model at block 320 may not include providing current data 322 to selected model 308. In some embodiments, selected model 308 may be configured to generate synthetic trace sensor data. Training may include providing true trace sensor data to the machine learning model. The training data (e.g., training set 302) may include attribute data. Attribute data includes information labeling training data, such as an indication of which tool the data is associated with, type and ID of sensor, indication of service lifetime of the tool (e.g., time elapsed since tool installation, time elapsed since a previous maintenance event, etc.), indication of a fault or pending fault in the manufacturing equipment that may be reflected in the training data, etc. Use of selected model 308 may include providing instructions to the model to generate synthetic trace sensor data. Use of selected model 308 may include providing one or more attributes. Data generated may conform with the one or more attributes, e.g., synthetic data may be generated that resembles data from a particular sensor, data collected when a fault is present in the manufacturing equipment, etc.

In some embodiments, the performance of a machine learning model trained, validated, and tested by system 300 may deteriorate. For example, a manufacturing system associated with the trained machine learning model may undergo a gradual change or a sudden change. A change in the manufacturing system may result in decreased performance of the trained machine learning model. A new model may be generated to replace the machine learning model with decreased performance. The new model may be generated by altering the old model by retraining, by generating a new model, etc. In some embodiments, a combination of several types of data may be utilized for retraining. In some embodiments, a combination of current data 322 and additional training data 346 may be utilized for training. Additional training data may include many of the same types of data as training data 364, such as historical data, synthetic data, etc.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIG. 3 depicts a system configured for training, validating, testing, and using one or more machine learning models. The machine learning models are configured to accept data as input (e.g., set points provided to manufacturing equipment, sensor data, metrology data, etc.) and provide data as output (e.g., predictive data, corrective action data, classification data, etc.). In some embodiments, a model may receive manufacturing parameters and sensor data, and be configured to output a list of components predicted to contribute to faults in the manufacturing system. Partitioning, training, validating, selection, testing, and using blocks of system 300 may be executed similarly to train a second model, utilizing different types of data. Retraining may also be done, utilizing current data 322 and/or additional training data 346.

FIGS. 4A-C are flow diagrams of methods 400A-C associated with training and utilizing machine learning models, according to certain embodiments. Methods 400A-C may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-C may be performed, in part, by predictive system 110. Method 400A may be performed, in part, by predictive system 110 (e.g., server machine 170 and data set generator 172 of FIG. 1, data set generators 272A-B of FIGS. 2A-B). Predictive system 110 may use method 400A to generate a data set to at least one of train, validate, or test a machine learning model, in accordance with embodiments of the disclosure. Methods 400B-C may be performed by predictive server 112 (e.g., predictive component 114) and/or server machine 180 (e.g., training, validating, and testing operations may be performed by server machine 180). In some embodiments, a non-transitory storage medium stores instructions that when executed by a processing device (e.g., of predictive system 110, of server machine 180, of predictive server 112, etc.) cause the processing device to perform one or more of methods 400A-C.

For simplicity of explanation, methods 400A-C are depicted and described as a series of operations. However, operations in accordance with this disclosure can occur in various orders and/or concurrently and with other operations not presented and described herein. Furthermore, not all illustrated operations may be performed to implement methods 400A-C in accordance with the disclosed subject matter. In addition, those skilled in the art will understand and appreciate that methods 400A-C could alternatively be represented as a series of interrelated states via a state diagram or events.

FIG. 4A is a flow diagram of a method 400A for generating a data set for a machine learning model, according to some embodiments. Referring to FIG. 4A, in some embodiments, at block 401 the processing logic implementing method 400A initializes a training set T to an empty set.

At block 402, processing logic generates first data input (e.g., first training input, first validating input) that may include one or more of sensor, manufacturing parameters, metrology data, etc. In some embodiments, the first data input may include a first set of features for types of data and a second data input may include a second set of features for types of data (e.g., as described with respect to FIG. 3). Input data may include historical data and/or synthetic data in embodiments.

In some embodiments, at block 403, processing logic optionally generates a first target output for one or more of the data inputs (e.g., first data input). In some embodiments, the first target output is predictive data. In some embodiments, input data may be in the form of sensor data and target output may be a list of components likely to be faulty, as in the case of a machine learning model configured to identify failing manufacturing systems. In some embodiments, no target output is generated (e.g., an unsupervised machine learning model capable of grouping or finding correlations in input data, rather than requiring target output to be provided). In some embodiments, an unsupervised machine learning model may be configured to generate synthetic trace sensor data.

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing a machine learning model, such as synthetic data generator 174 or model 190 of FIG. 1. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210B) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, a model (e.g., model 190) can be at least one of trained using training engine 182 of server machine 180, validated using validating engine 184 of server machine 180, or tested using testing engine 186 of server machine 180. The trained model may be implemented by predictive component 114 (of predictive server 112) to generate predictive data 168 for performing signal processing, to generate synthetic sensor data 162, or for performing corrective action associated with manufacturing equipment 124.

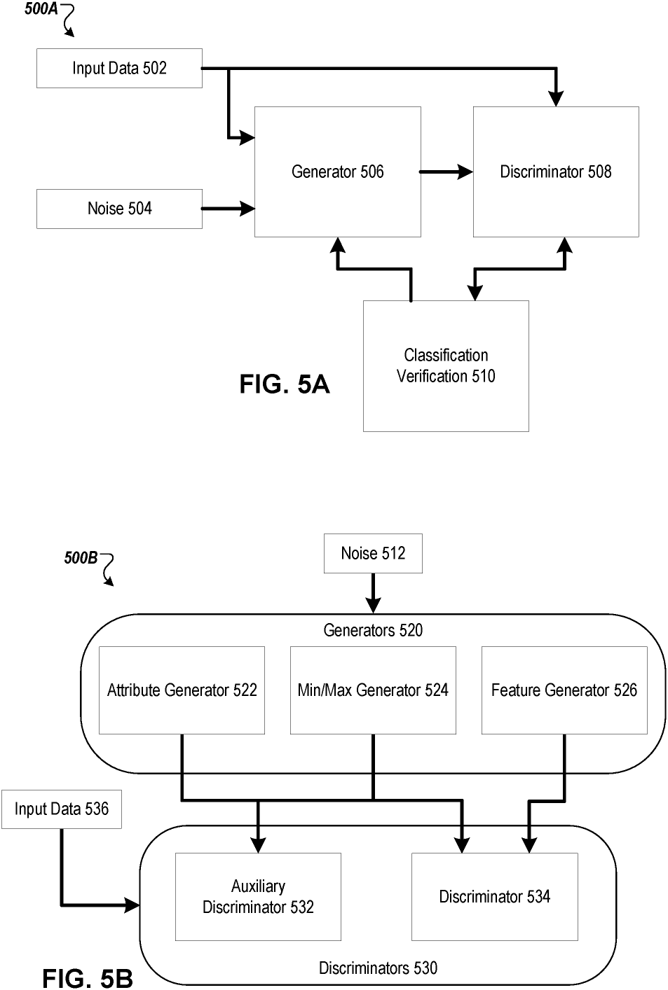

FIG. 4B is a flow diagram of a method 400B for generating synthetic time series sensor data (e.g., synthetic time trace data), according to some embodiments. At block 410 of method 400B, processing logic provides a random or pseudo-random input to a trained machine learning model. The trained machine learning model is configured to generate synthetic sensor time series data for a processing chamber. A seed of random or pseudo-random numbers is provided to the trained machine learning model, to allow generation of different synthetic time traces. In some embodiments, the random numbers do not have a physical meaning, e.g., do not correspond to data values of some points of the time trace. In some embodiments, the trained machine learning model includes one or more generators and one or more discriminators. In some embodiments, the trained machine learning model is a generative adversarial network (GAN). Example architectures of GAN models are presented in more detail in connection with FIGS. 5A-B. In some embodiments, the random number input is provided to a generator.

At block 412, processing logic provides data indicative of one or more attributes of a target synthetic sensor time series data to the trained machine learning model. The attribute data may indicate one or more conditions of the target synthetic sensor time series. Attribute data may indicate a manufacturing system, a product design, a sensor ID, a system fault, a service lifetime, etc. In some embodiments, synthetic data is to be used to train a machine learning model to recognize a particular situation. Providing attribute data to a generator enables generation of a large amount of data associated with that situation, such as a particular system fault.

At block 414, processing logic receives an output from the trained machine learning model. The output includes synthetic trace sensor data associated with the processing chamber. The output is generated in view of the one or more attributes. In some embodiments, the synthetic data output may be used to train a second machine learning model.

FIG. 4C is a flow diagram of a method 400C for generating and using synthetic sensor trace data, according to some embodiments. At block 420, processing logic provides historical data including trace sensor data (e.g., time series data) as training input to train a first machine learning model. The first machine learning model may be a GAN. Input data may be provided along with one or more associated attributes, e.g., data indicating tool ID, sensor ID, process recipe, service lifetime, etc. The GAN may train a generator model utilizing a discriminator model. Trace sensor data may include data from many types of sensors associated with a manufacturing system, processing chamber, etc. In some embodiments, time trace sensor data may include a measure of energy provided to a radio frequency component of a processing chamber, such as a radio frequency plasma generation component. Time trace sensor data may include frequency, power, voltage, or current supplied to such a component. In some embodiments, time trace sensor data may include a measure of one or more of power, voltage, or current supplied to a heater. In some embodiments, time trace sensor data may include power, voltage, or current supplied to a substrate support. In some embodiments, time trace sensor data may include pressure or temperature.

At block 421, processing logic provides data indicative of one or more attributes of a target synthetic sensor time series data to the trained first machine learning model. The attributes provided may reflect one or more time traces of interest, e.g., one or more conditions where a large amount of synthetic sensor data is to be generated. A set of random or pseudo-random numbers may be provided to the trained first machine learning model. The random input may be used as a seed for generation of synthetic data. At block 422, processing logic receives output from the trained first machine learning model. The output includes synthetic trace sensor data. The output data may also include data indicative of one or more associated attributes. Operations of blocks 421 and 422 may share features with operations of FIG. 4B.

At block 423, processing logic provides the output from the trained first machine learning model as training input to train a second machine learning model. In some embodiments, the output data is provided with historical sensor data, e.g., true sensor data collected during one or more processing runs. Processing logic provides data indicative of at least one of the one or more attributes as target output to train a second machine learning model. In some embodiments, synthetic data is to be generated for training a model to predict a fault, an anomaly, or predict performance of a manufacturing equipment that has been in service for an amount of time. In some embodiments, synthetic data may be generated associated with a particular tool, sensor, product design, etc. Such information may be provided to train the second machine learning model as attribute data.

At block 424, processing logic provides current sensor data to the trained second machine learning model. The trained second machine learning model may be configured to accept as input sensor data and produce as output predictive data, e.g., predicted metrology data, predicted anomalies in a product, predicted faults in a manufacturing system, predicted processing operation progress, etc. At block 425, predictive data output is received from the trained second machine learning model. At block 426, a corrective action is performed in view of the output from the trained second machine learning model. The corrective action may include scheduling maintenance of processing equipment, updating a process recipe, sending an alert to a user, etc.

FIGS. 5A-B are depictions of processes and architecture of training and operating generative adversarial networks, according to some embodiments. FIG. 5A depicts a simple GAN 500A. In training, input data 502 is provided to discriminator 508. Discriminator 508 is configured to distinguish whether input data 502 is true data or synthetic data. Discriminator 508 is trained until it achieves an acceptable accuracy. Accuracy parameters may be tuned based on application, for example, the volume of training data available.

In some embodiments, generator 506 may be provided with input data 502 (e.g., drawn from the same data set as the data used to train discriminator 508) to train generator 506 to produce plausible synthetic data. Generator 506 is provided with noise 504, e.g., random input, such as a fixed-length vector of pseudo-random values. Generator 506 uses the random input as a seed to generate synthetic data. Generator 506 provides the synthetic data to discriminator 508. Further input data 502 (e.g., true data drawn from the same set as the data used to train discriminator 508) is also provided to discriminator 508. Discriminator 508 attempts to distinguish input data 502 from synthetic data provided by generator 506.

Discriminator 508 provides classification results (e.g., whether each data set supplied to discriminator 508 has been labeled as true or synthetic) to classification verification module 510. Classification verification module 510 determines whether one or more data sets has been labeled correctly by discriminator 508. Feedback data indicative of labeling accuracy is provided both to discriminator 508 and generator 506 (e.g., feedback data indicative of how accurately the discriminator distinguished synthetic from measured sensor time series data). Both generator 506 and discriminator 508 are updated in view of the information received from classification verification module 510. Generator 506 is updated to generate synthetic data that is more successful at replicating features of input data 502, e.g., to generate synthetic data that is more often labeled as true data by discriminator 508. Discriminator 508 is updated to improve accuracy of distinguishing true from synthetic data. Training processes may be repeated until generator 506 reaches an accuracy threshold, e.g., until generator 506 produces a large enough portion of data that is not correctly classified by discriminator 508.

FIG. 5B is a block diagram depicting operating processes of an example GAN 500B for generating synthetic trace data, according to some embodiments. In some embodiments, example GAN 500B may include many features discussed in connection with FIG. 5A.

In some embodiments, GAN 500B includes a set of generators 520 and a set of discriminators 530. In some embodiments, discriminators 530 are trained by supplying them with input data 536. Discriminators 530 are configured to distinguish between true data and synthetic data. Generators 520 may be configured to generate synthetic data. Generators 520 may be seeded with noise 512, e.g., random or pseudo-random input.

In some embodiments, GAN 500B may include multiple generators 520 and/or multiple discriminators 530. Discriminators 530 may be configured to accept output data from different generators or sets of generators. In some embodiments, generators 520 may be configured to generate attribute data via attribute generator 522 and associated data (e.g., synthetic sensor time trace data) via feature generator 526. In some embodiments, feature generator 526 is configured to generate normalized data (e.g., synthetic sensor data with values varying from zero to one), and min/max generator 524 is configured to generate a minimum and maximum value for the data. In some embodiments, the approach of separating min/max generator 524 from feature generator 526 may improve the performance of generators 520.

In some embodiments, noise 512 may be provided to attribute generator 522 and min/max generator 524. In some embodiments, a different set of noise (e.g., a different set of random inputs) may be provided to each generator of generators 520. In some embodiments, output of attribute generator 522 and min/max generator 524 (e.g., synthetic attribute data and synthetic min/max data) may be provided to auxiliary discriminator 532. Auxiliary discriminator 532 may determine if the combination of attributes and min/max values are likely to be associated with true data. A preliminary determination may be performed, saving processing power of generating and/or discriminating synthetic data from feature generator 526. Output of generators 520 may all be provided to discriminator 534. Discriminator 534 may distinguish true data from synthetic data, including attribute data, min/max data, trace sensor data, etc. In some embodiments, min/max generator 524 may be an optional feature, e.g., GAN 500B may be configured to normalize data from feature generator 526, or configured to produce data values via feature generator 526.

In some embodiments, feature generator 526 may include a machine learning generator model designed to generate sequential or time trace (e.g., time series) data. In some embodiments, feature generator 526 may include a recurrent neural network. A recurrent neural network routes at least some outputs of neurons (e.g., generated time trace data) to input of another neuron (e.g., a neuron associated with a later time point). In some embodiments, a recurrent neural network may essentially include a single neuron, with output cycled back as input to generate a sequence of synthetic data. The recurrent neural network is able to learn input-output mappings that depend on both a current input and past inputs. In this way, later data points may depend upon earlier data points, and sequential or time series data may be generated.

In some embodiments, a target shape or pattern may be included in synthetic data. For example, a spike in data values recorded by a sensor may be simulated. In some embodiments, feature generator 526 may accept instructions to facilitate generation of synthetic data included a target shape or pattern. A range or distribution of locations (e.g., in time), values, shapes, etc., may be provided to feature generator 526. Feature generator 526 may generate data with a target shape or pattern expressed in accordance with a distribution of properties, e.g., a spike may appear in many sets of synthetic trace sensor data in a range of locations, reaching a range of heights, with a range of widths.

In some embodiments, synthetic data (e.g., data output from generators 520) may be utilized to train one or more machine learning models. In some embodiments, synthetic data may be utilized to train a machine learning model configured for event detection, e.g., configured to determine if trace data is within normal variations or indicative of a system anomaly. In some embodiments, synthetic data may be utilized to generate a robust model - synthetic data may be generated with a higher noise level than true data, and a machine learning model trained with the synthetic data may be capable of providing useful output for a wider variety of input than a model trained only on true data. In some embodiments, synthetic data may be utilized to test a model for robustness. In some embodiments, synthetic data may be utilized to generate a model for anomaly detection and/or classification. In some embodiments, synthetic data may be provided to train a machine learning model as training input, and one or more attribute data (e.g., attribute data indicating a system fault) may be provided to train the machine learning model as target output. In some embodiments, attribute data may include an indication of a service lifetime of a manufacturing system, e.g., time since installation of the system, number of products produced since installation of the system, time or number of products produced since the last maintenance event, etc.

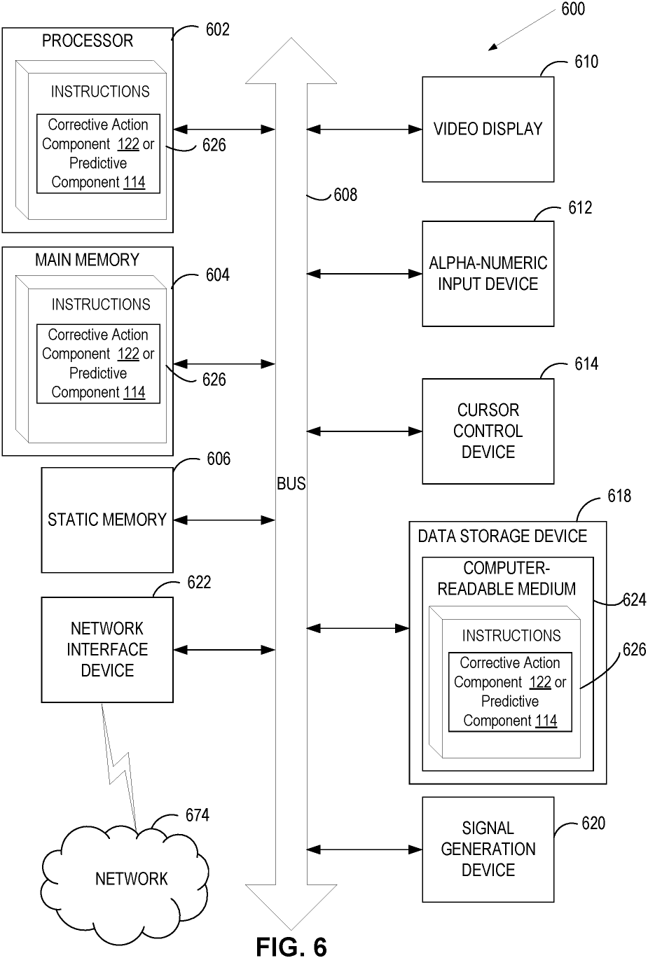

FIG. 6 is a block diagram illustrating a computer system 600, according to some embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., predictive component 114, corrective action component 122, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

1. A method, comprising:
providing a random or pseudo-random input to a first trained machine learning model trained to generate synthetic sensor time series data for a processing chamber;
providing first data indicative of one or more attributes of target synthetic sensor time series data to the first trained machine learning model; and
receiving an output from the first trained machine learning model, wherein the output comprises synthetic sensor time series data associated with the processing chamber, wherein the output is generated in view of the first data indicative of one or more attributes.

2. The method of claim 1, further comprising:
training the first machine learning model, wherein training the model comprises:
causing the first machine learning model to generate synthetic sensor time series data;
providing the synthetic sensor time series data to a second machine learning model;
providing measured sensor time series data to the second machine learning model, wherein the second machine learning model is configured to distinguish between synthetic sensor time series data and measured sensor time series data;
providing feedback data to the first machine learning model, indicative of how accurately the second machine learning model distinguished synthetic from measured sensor time series data; and
updating the first machine learning model to generate synthetic sensor time series data that the second machine learning model less accurately distinguishes from measured sensor time series data.

3. The method of claim 1, wherein the first trained machine learning model comprises a generator of a generative adversarial network.

4. The method of claim 1, wherein the first trained machine learning model comprises a recurrent neural network model.

5. The method of claim 1, wherein the synthetic sensor time series data comprises data corresponding to one or more of:
power, voltage, or current supplied to a component of the processing chamber; pressure; or
temperature.

6. The method of claim 1, further comprising:
training a second machine learning model, wherein training the second machine learning model comprises:
providing the output synthetic sensor time series data to the second machine learning model as training input; and
providing first data indicative of one or more attributes associated with the output synthetic sensor time series data to the second machine learning model as target output, wherein the second machine learning model is configured to predict attributes of the processing chamber based on measured sensor time series data of the processing chamber.

7. The method of claim 6, wherein the second machine learning model is configured to detect one or more anomalies associated with measured sensor time series data of the processing chamber.

8. The method of claim 1, wherein an attribute of target synthetic sensor time series data comprises one or more of:
time since installation of the processing chamber;
time since a previous maintenance event of the processing chamber; or
a fault present in the processing chamber.

9. A system, comprising memory and a processing device coupled to the memory, wherein the processing device is configured to:
provide a random or pseudo-random input to a first trained machine learning model, wherein the first trained machine learning model is trained to generate synthetic sensor time series data for a processing chamber;
provide first data indicative of one or more attributes of target synthetic sensor time series data to the first trained machine learning model; and
receive an output from the first trained machine learning model, wherein the output comprises synthetic sensor time series data associated with the processing chamber, wherein the output is generated in view of the first data indicative of one or more attributes.

10. The system of claim 9, wherein the processing device is further configured to:
train the first machine learning model, wherein training the model comprises:
causing the first machine learning model to generate synthetic sensor time series data;
providing the synthetic sensor time series data to a second machine learning model;
providing measured sensor time series data to the second machine learning model, wherein the second machine learning model is configured to distinguish between synthetic sensor time series data and measured sensor time series data;
providing feedback data to the first machine learning model indicative of how accurately the second machine learning model distinguished synthetic from measured sensor time series data; and
updating the first machine learning model to generate synthetic sensor time series data that the second machine learning model less accurately distinguishes from measured sensor time series data.

11. The system of claim 9, wherein the first trained machine learning model comprises a generator of a generative adversarial network.

12. The system of claim 9, wherein the first trained machine learning model comprises a recurrent neural network model.

13. The system of claim 9, wherein the synthetic sensor time series data comprises data corresponding to one or more of:
power, voltage, or current supplied to one or more of:
a radio frequency plasma generation component;
a heater; or
a substrate support,
pressure; or
temperature.

14. The system of claim 9, wherein the processing device is further configured to:
train a second machine learning model, wherein training the second machine learning model comprises:
providing the output synthetic sensor time series data to the second machine learning model as training input; and
providing first data indicative of one or more attributes associated with the output synthetic sensor time series data to the second machine learning model as target output, wherein the second machine learning model is configured to predict attributes of the processing chamber based on measured sensor time series data of the processing chamber.

15. The system of claim 14, wherein the second machine learning model is configured to detect one or more anomalies associated with measured sensor time series data of the processing chamber.

16. The system of claim 9, where an attribute of target synthetic sensor time series data comprises one or more of:
time since installation of the processing chamber;
time since a previous maintenance event of the processing chamber; or
a fault present in the processing chamber.

17. A non-transitory machine-readable storage medium storing instructions which, when executed, cause a processing device to perform operations comprising:
providing a random or pseudo-random input to a first trained machine learning model trained to generate synthetic sensor time series data for a processing chamber;
providing first data indicative of one or more attributes of target synthetic sensor time series data to the first trained machine learning model; and
receiving an output from the first trained machine learning model, wherein the output comprises synthetic sensor time series data associated with the processing chamber, generated in view of the first data indicative of one or more attributes.

18. The non-transitory machine-readable storage medium of claim 17, the operations further comprising:
training the first machine learning model, wherein training the model comprises:
causing the first machine learning model to generate synthetic sensor time series data;
providing the synthetic sensor time series data to a second machine learning model;
providing measured sensor time series data to the second machine learning model, wherein the second machine learning model is configured to distinguish between synthetic sensor time series data and measured sensor time series data;
providing feedback data to the first machine learning model, indicative of how accurately the second machine learning model distinguished synthetic from measured sensor time series data; and
updating the first machine learning model to generate synthetic sensor time series data that the second machine learning model less accurately distinguishes from measured sensor time series data.

19. The non-transitory machine-readable storage medium of claim 17, where an attribute of target synthetic sensor time series data comprises one or more of:
time elapsed since installation of the processing chamber;
time elapsed since a previous maintenance event of the processing chamber; or
a fault present in the processing chamber.

20. The non-transitory machine-readable storage medium of claim 17, the operations further comprising:
training a second machine learning model, wherein training the second machine learning model comprises:
providing the output synthetic sensor time series data to the second machine learning model as training input; and
providing first data indicative of one or more attributes associated with the output synthetic sensor time series data to the second machine learning model as target output, wherein the second machine learning model is configured to predict attributes of the processing chamber based on measured sensor time series data of the processing chamber.
